(19) United States
(12) Patent Application Publication
(10) Pub. No.: US 2003/0057024 A1
(43) Pub. Date: Mar. 27, 2003

(54) Detachable oil drain assembly

(76) Inventor: Jeffrey Robert Braun, Colgate, WI (US)

Correspondence Address: Brian H. Buck, c/o Deere & Company, One John Deere Place, Moline, IL, 61265-8098, US

(21) Appl. No.: 09/964,710

(22) Filed: Sep. 26, 2001

(51) Int. Cl. F16C 3/14

(52) U.S. Cl. 184/1.5

(57) ABSTRACT

An apparatus for permitting the draining of liquid such as oil from a small internal combustion engine is provided. The apparatus consists of two separate components so as to allow for its easy use and inexpensive manufacture. Additionally, the apparatus is constructed so as to not to require costly or complex valve assemblies so as to remove the potential for leaking and associated undesirable effects.

### FIELD OF THE INVENTION

This invention relates to assemblies used in draining liquid from a container such as an internal combustion engine, and more specifically, to structure which accomplishes the draining function without the use of complex valves or other cost increasing components.

### BACKGROUND OF THE INVENTION

Changing the engine operating oil of an internal combustion engine often requires a number of steps by the person attempting the procedure. These steps have included removing and subsequently re-adjusting certain apparatus which retains the oil within the engine. In the particular situation involving smaller sized engines, it has been common for this apparatus to consist of or include either a plug assembly or nipple and cap assembly that is adapted with the engine crankcase so as to retain the oil therein. Additionally, assemblies containing extensive valve configurations have also been used to permit and control the flow of oil from the engine as the drainage process occurs.

However, the above assemblies have a variety of undesirable aspects associated with them. First, use of the above has often caused the task of changing oil to be quite cumbersome and dirty since the oil ordinarily rushes from the crankcase once the plug is removed or, in the case of a valve assembly, oil leaks from the assembly as a result of a faulty seal therein. In each of the above cases, oil has become spilled over members of the engine and creates undesired consequences such as having to clean the areas on which the oil has spilled as well as fumes that occur upon operation of the engine. Secondly and in the particular case whereby a valve assembly is used to drain spent oil, there exists the unattractive prospect of increased cost(s) of manufacture simply by virtue of the inclusion of added parts or components used in regulating the flow of oil as it passes through the assembly. Thirdly, at least in the case of the nipple assembly, a tool or tools is/are required to adjust its nipple component into and out of the engine. When used, the tool or tools hold(s) onto the cap after it has been attached to the nipple whereby both are then positioned into the crankcase. When removal of the cap occurs, rotation thereof turns both the nipple and the cap out of the crankcase causing oil to drain all over the surface of the frame.

Thus, it would be beneficial to provide an oil drain apparatus that permits an operator to easily, cleanly and inexpensively cause the draining of oil in an internal combustion engine such as those used with lawn and garden tractors.

### SUMMARY OF THE INVENTION

Accordingly, there is provided an apparatus that permits an operator to quickly and easily drain oil from the engine to which it is attached. Additionally, the apparatus is constructed inexpensively so as to require as few components as necessary to permit draining to occur whereas this also includes not requiring the use of tools.

To make the apparatus easy to use and inexpensive to construct, it includes only two parts, one of which is a single longitudinally extending tube. The tube includes a bore extending between its first and second ends which serves as a passageway through which oil flows as it is drained from the crankcase. At its first end, the tube is configured to matingly engage the engine crankcase. At its second end, projections are formed on opposite sides thereof and onto which a second part in the form of a cap, preferably formed of an elastomeric material such as nylon, may interlock to close off and thereby contain oil within the tube or be detached therefrom to allow oil to drain from the engine.

To permit an operator to quickly and easily drain oil from the crankcase, the operator need only twist and pull the cap from the second end of the tube. As such, the operator is not required to use a tool or tools of any particular type to drain and thereafter contain the engine oil since the cap may be removed and replaced with a simple pull off of or push onto the tube, respectively.

To drain the oil more cleanly so as to avoid its spillage on the frame, the cap is provided to extend beyond the frame when it is positioned to release the oil. As such, time spent in cleaning the engine components as well as the area in which the oil was changed may be substantially reduced, if not avoided, since release of the oil will occur away from the engine frame.

Thus, there is provided an apparatus which may be used to drain oil from an engine in a manner that is uncomplicated, clean and inexpensive as a result of its construction and use.

### BRIEF DESCRIPTION OF THE DRAWINGS

FIG. 1 is a side view of the oil drain apparatus of the present invention whereby the cap is in its fully closed and locked position.

FIG. 2 is a side view of the oil drain apparatus whereby the cap is in an extended position such that it may be detached from the remainder of the apparatus to permit the draining of oil therefrom.

FIG. 3 is an exploded view according to FIG. 2

FIG. 4 is a side perspective and exploded view according to FIG. 2 and which shows the locking pins used to secure the cap of the oil drain assembly.

FIG. 5 is a plan view of the tube member of the present drain assembly showing the bore extending therethrough.

FIG. 6 is a side perspective view of the interior of the cap of the oil drain assembly.

FIG. 7 is a side perspective view of the mounting of the assembly of the present invention on the frame of a lawn and garden tractor whereby the assembly extends beyond the frame.

### DESCRIPTION OF THE PREFERRED EMBODIMENT

Looking to FIG. 1, there is provided a drain assembly 10, preferably used in draining liquids such as the engine oil of a small internal combustion engine which is ordinarily used with vehicles such as lawn and garden tractors. Although shown throughout FIGS. 1-4 in its substantially upright position, it is intended that the assembly 10 be mounted horizontally so as to extend laterally beyond the tractor frame 11. However, mounting may occur in any orientation relative to the engine and frame 11.

As seen in FIG. 1 and more clearly in FIGS. 3 and 4, the assembly 10 consists of a first cylindrical member preferably formed as a tube 12, having first and second ends 14, 16 respectively, and a bore 18 extending therebetween. The first end 14 is threaded for engagement with a crankcase 19 of the engine. A nut 20 is disposed intermediate the first and second ends 14, 16 so as to provide an operator a surface on which the assembly 10 may be grasped so as to be securely tightened with the engine. The second end 16 includes an outer face 22 adjacent its edge 24 which includes an outwardly and downwardly extending beveled lip 26 relative to the edge 24. Below the lip 26, as seen in FIGS. 3 and 4, the second end 16 includes a groove 28 formed therein and in which is placed an o-ring 30. At its second end 16 and intermediate the groove 28 and nut 20, the first member 12 includes offset and opposed projections 32 on an exterior surface 34 as shown in FIG. 5.

As emphasized in FIGS. 3 and 4, the assembly 10 further includes a second cylindrical member provided in the form of a cap 36. On opposing sides of the cap 36, slots 38 and 40 are formed and provide channels through which the projections 32 are positioned, as discussed below. The slots 38, 40 are bordered by first and second pairs of detents or tabs 42, 44, respectively, which extend from members of the cap 36 outlined by the slots 38, 40 as is shown most clearly in FIGS. 1 and 3. Provided above the slots 38, 40 and around the side surface 46 of the cap 36 are protrusions or grips 48.

In its closed or sealed position shown in FIG. 1, the peripheral members of the cap 36 will abut against the projections 32 whereby an operator will have rotated the cap 36 counterclockwise or moved it in a first direction to cause the projections 32 to be positioned past the detents 42 and abut the cap 36. Additionally, the cap 36 includes a concave member 50 or circumferential indentation on its top surface 52 as shown in FIG. 3. The concave member 50 includes an upwardly sloped incline, as shown in FIG. 6, which partially abuts the beveled lip 26 so as to decrease the force exerted on the o-ring 30 when the cap 36 is in its fully closed position as illustrated in FIG. 1. As shown in FIG. 6, the cap 36 is constructed with a ridge 56 on its inside surface which extends completely therearound to permit the cap 36 to be slipped onto and off of the tube 12 with greater ease.

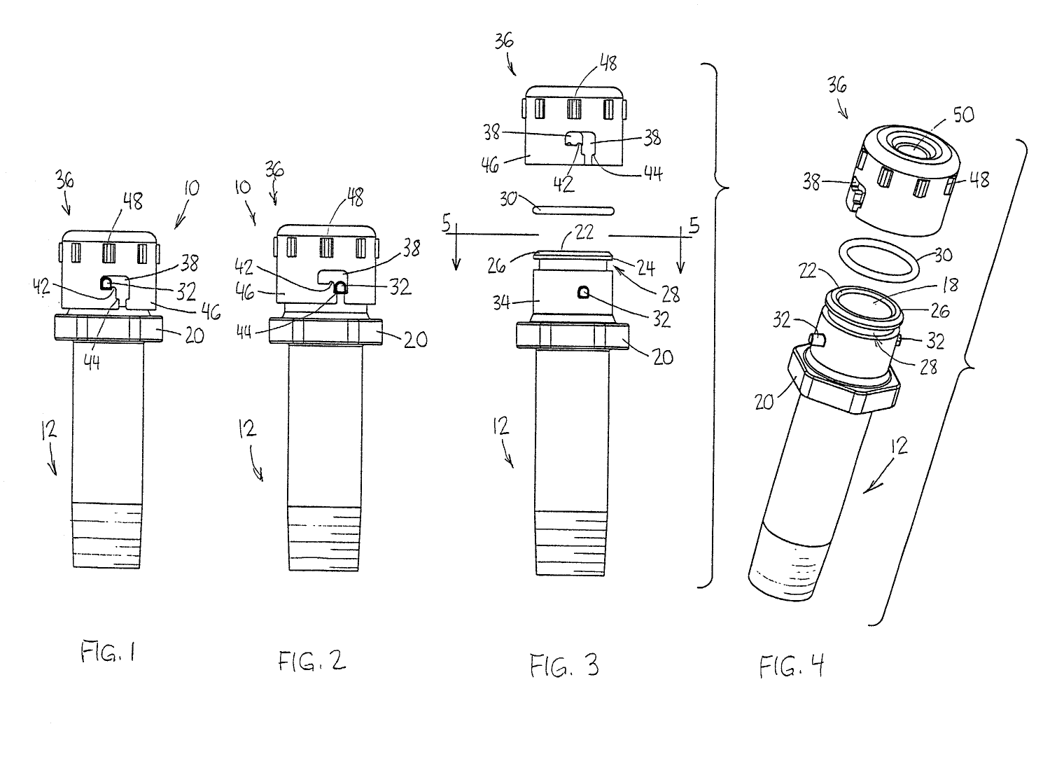

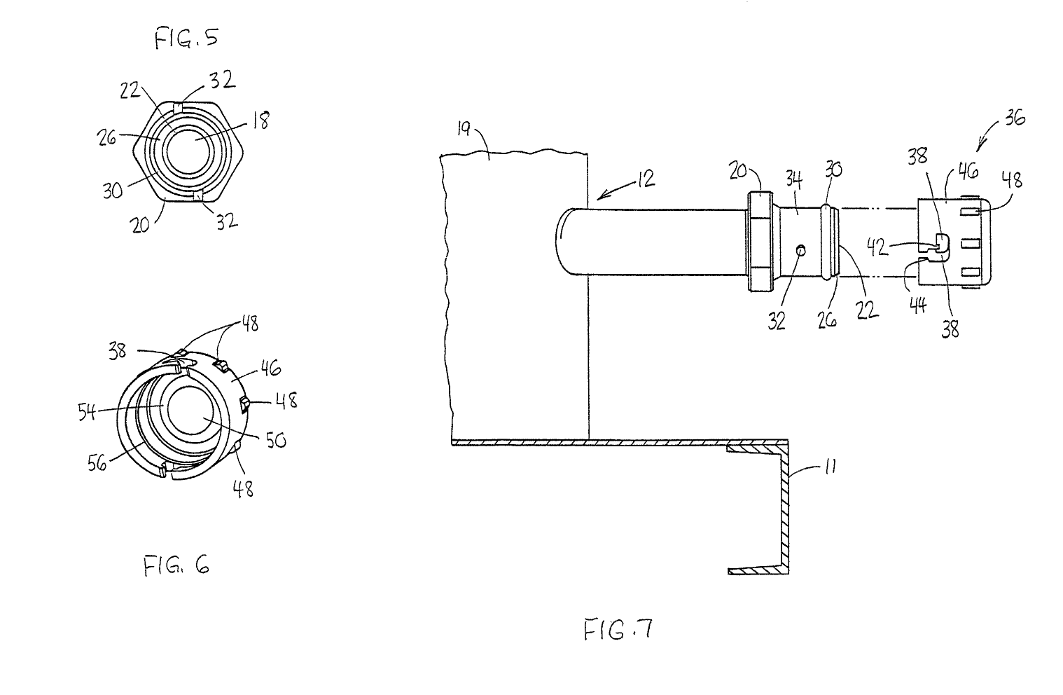

To begin the process of draining oil from the engine, it is necessary only that the operator grasp the grips or protrusions 48 and rotate the cap 36 clockwise or move it in a second direction so as to cause the projections 32 to be positioned to the right of the detents 42. Thereafter, the cap 36 can be pulled so as to change the positioning of the respective projections 32 relative to the slots 38, 40 and cause them to abut against the detents 44 as also shown in FIG. 2. When in this position, the o-ring 30 provides a seal between the first and second members 12, 36 so as to contain oil that flows into the cap 36 as a result of its outward extension. Accordingly, the oil does not leak or otherwise exit the assembly 10 prior to an intentional detachment of the cap 36 from the first member 12. Additionally, extension of the cap 36, as shown in FIG. 2, permits the assembly 10 to allow draining of the oil beyond the frame on which the engine is mounted. To thereafter permit draining of the oil from the engine and the assembly 10, the operator need only pull the cap 36 outwardly past the projections 32 of the first member 12 such that they move beyond the detents 44 as shown in FIG. 7.

Thus, there is provided an apparatus that permits an operator to easily, cleanly and inexpensively change the oil of a small internal combustion engine such as those utilized with smaller sized lawn and garden tractors.

Having described the preferred embodiment, it will become apparent that various modifications can be made without departing from the scope of the invention as defined in the accompanying claims.

I claim:

1. A drain assembly for draining liquids used with an internal combustion engine, the assembly comprising:
a) a longitudinally extending first cylindrical member having first and second ends and a bore therebetween for allowing the storage or release of liquid, the first end being threaded for engagement with the engine and the second end having an outer face and a beveled lip extending therefrom;
b) a nut intermediate the ends for allowing the assembly to be secured with the engine;
c) a plurality of radially disposed projections adjacent the nut;
d) a groove intermediate the projections and the lip;
e) a o-ring disposed within the groove; and
f) a second cylindrical member having coaxially opposed slots, first and second pairs of detents along the slots, the second member being matingly engageable with the projections to retain contact between the first and second members, the second member being sealed against the first member at the o-ring and closed at an end thereof so as to retain liquid within the bore when the first and second members remain in contact with each other.

2. The assembly as recited in claim 1 wherein:
the second cylindrical member is rotatable with respect to the second end of the first cylindrical member, movement of the second member in a first direction causing the projections to extend beyond the first pair of detents and retain contact between the closed member and the outer face, movement of the second member in a second direction and extension thereof causing the projections to extend beyond the second pair of detents so as to permit detachment of the second member from the first member whereby detachment of the first and second members permits draining of liquid retained within the bore.

3. The assembly as recited in claim 2 wherein:
the second cylindrical member includes exterior and interior surfaces, a concave member at an exterior surface thereof, the concave member creating an upwardly sloped incline within the interior surface that partially abuts against a segment of the lip to decrease force that is exerted on the o-ring when the first and second members contact each other.

4. The assembly as recited in claim 3 wherein:
the second cylindrical member is a cap.

5. The assembly as recited in claim 4 wherein:
the cap includes grips on its outside surface for permitting it to be rotated about the second end of the first member and then detached therefrom

6. For use with an internal combustion engine mounted on a frame, an improved drain assembly for draining liquid therefrom, the assembly comprising:
a) a first cylindrical member having first and second ends and including a bore extending therebetween, the bore providing a passageway in and through which liquid is disposed; and
b) a second cylindrical member having an open and closed end, the open end communicating with the second end of the first cylindrical member to permit the transfer of liquid therebetween, the closed end permitting retention of liquid transferred from the first cylindrical member into the second cylindrical member, the second cylindrical member being extendable past the frame to which it is mounted so as to retain the liquid transferred thereto.

7. The assembly as recited in claim 6 wherein:
the first end of the first cylindrical member includes projections on a side thereof.

8. The assembly as recited in claim 7 wherein:
the first end of the first cylindrical member includes an outer face and a beveled lip extending therefrom, a groove adjacent the lip and a o-ring disposed within the groove.

9. The assembly as recited in claim 8 wherein:
the second cylindrical member includes coaxially opposed slots, and first and second pairs of detents along members of the slots, the second member being matingly engageable with the projections to retain contact between the first and second members.

10. The assembly as recited in claim 9 wherein:
the second cylindrical member is rotatable with respect to the second end of the first cylindrical member, movement of the second member in a first direction causing the projections to extend beyond the first pair of detents and retain contact between the closed member and the outer face, movement of the second member in a second direction and extension thereof causing the projections to extend beyond the second pair of detents so as to permit detachment of the second member from the first member whereby detachment of the first and second members permits draining of liquid retained within the bore.

11. The assembly as recited in claim 10 wherein:
the second cylindrical member includes exterior and interior surfaces, a concave member at an exterior surface thereof, the concave member creating an upwardly sloped incline within the interior surface that partially abuts against a segment of the lip to decrease force that is exerted on the o-ring when the first and second members contact each other.

12. The assembly as recited in claim 11 wherein:
the second cylindrical member is a cap.

13. The assembly as recited in claim 12 wherein:
the cap includes grips on its outside surface for permitting it to be rotated about the second end of the first member and then detached therefrom.

14. A drain assembly for draining liquids from a container, the assembly comprising:
a) a longitudinally extending first cylindrical member having first and second ends and a bore therebetween for allowing the flow of liquid therethrough, the first end being attachable to the container and the second end having an outer face and a beveled lip extending therefrom;
b) at least one radially extending projection carried adjacent the lip;
c) a groove intermediate the projection and the lip;
d) an o-ring disposed within the groove; and
e) a second cylindrical member having a slot with first and second pairs of detents, the slot of the second member receivingly engaging with the projection to secure the first and second members together, the second member being sealed against the first member at the o-ring and closed at an end thereof so as to retain liquid within the bore when the first and second members remain in contact with each other.
